(19) United States
(12) Patent Application Publication
(10) Pub. No.: US 2012/0029669 A1
(43) Pub. Date: Feb. 2, 2012

(54) RECORDING AND REPRODUCING APPARATUS

(75) Inventor: Keita Kato, Kawanishi-shi (JP)

(73) Assignee: SANYO ELECTRIC CO., LTD., Osaka (JP)

(21) Appl. No.: 13/118,994

(22) Filed: May 31, 2011

(30) Foreign Application Priority Data
Jul. 27, 2010 (JP) 2010-168266

(51) Int. Cl. G06F 17/00

(52) U.S. Cl. 700/94

(57) ABSTRACT

A recording and reproducing apparatus includes a revolving switch capable of selecting a predetermined folder from among a plurality of folders in a recording medium corresponding to a revolved position, a recording setter which sets, upon a recording mode, a first folder corresponding to a revolved position of the revolving switch, as an allocation destination of content data to be recorded on the recording medium, and a reproducing setter which sets the content data allocated to a second folder corresponding to a revolved position of the revolving switch, as a reproducing destination. The first folder and the second folder become the same folder out of the plurality of folders in the recording medium on the condition that the revolved position of the revolving switch in the recording mode is the same as the revolved position of the revolving switch in the reproduction mode.

### CROSS REFERENCE OF RELATED APPLICATION

The disclosure of Japanese Patent Application No. 2010-168266, which was filed on Jul. 27, 2010, is incorporated here by reference.

### BACKGROUND OF THE INVENTION

1. Field of the Invention

The present invention relates to a recoding and reproducing apparatus which performs a recording process by allocating content data to a specific folder among a plurality of folders in a recording medium and then performs a reproducing process of reproducing the content data allocated to the specific folder.

2. Description of the Related Art

Conventionally, when a data file is recorded on a recording medium, there is appreciatedly used a recording and reproducing apparatus in which a specific folder is selected from a plurality of folders in the recording medium, and the data file is allocated to a selected folder and recorded.

However, in the conventional sound-recording and reproducing apparatus, there are at least following problems.

(1) Upon switching a folder A, a folder B and a folder C in the recording medium on which the data file is recorded, it is necessary to perform complicated operations such as switching the folder A to the folder B by pressing a folder button once and switching the folder B to the folder C by pressing the folder button once more.

(2) Upon reproducing, because it is impossible to know immediately which folder a data file wished to be reproduced is allocated to, it is necessary to perform a complicated operation to search for it.

(3) Because a sound-recording function setting and a reproducing function setting must to be set individually, it is necessary to perform a complicated operation to set them.

Thus, in the conventional sound-recording and reproducing apparatus, when the data file is recorded and reproduced, it is necessary to perform the complicated operations for selecting folders and the setting.

### SUMMARY OF THE INVENTION

According to the present invention, a recording and reproducing apparatus provided with a recording mode which performs a recording process of recording content data on a recording medium, a reproduction mode which performs a reproducing process of reproducing the content data recorded on the recording medium, and a revolving switch capable of selecting a predetermined folder from among a plurality of folders of the recording medium corresponding to a revolved position, comprises: a recording setter which sets, upon the recording mode, a first folder corresponding to a revolved position of the revolving switch, out of the plurality of folders in the recording medium, as an allocation destination of the content data to be recorded on the recording medium; a reproducing setter which sets the content data allocated to a second folder corresponding to a revolved position of the revolving switch, out of the plurality of folders in the recording medium, as a reproducing destination, wherein the first folder and the second folder become the same folder out of the plurality of folders in the recording medium on the condition that the revolved position of the revolving switch in the recording mode is same as the revolved position of the revolving switch in the reproduction mode.

The above described features and advantages of the present invention will become more apparent from the following detailed description of the embodiment when taken in conjunction with the accompanying drawings.

### BRIEF DESCRIPTION OF THE DRAWINGS

FIG. 1 is an outline view showing an IC recorder 10 according to this embodiment;

FIG. 2 is a block diagram showing one portion of a circuit configuration of the IC recorder 10 according to this embodiment;

FIG. 3 is an illustrative view showing a folder configuration of an external memory card 54 according to this embodiment;

FIG. 4 is an illustrative view showing a sound-recording function table related to folders and sound-recording functions in a sound-recording mode of the IC recorder 10 according to this embodiment;

FIG. 5 is an illustrative view showing one example of an operation manner in the sound-recording mode of the IC recorder 10 according to this embodiment;

FIG. 6 is an illustrative view showing a reproducing function table related to folders and reproducing functions in a reproduction mode of the IC recorder 10 according to this embodiment;

FIG. 7 is an illustrative view showing one example of an operation manner in the reproduction mode of the IC recorder 10 according to this embodiment;

FIG. 8 is a flowchart showing one portion of behavior of the IC recorder 10 according to this embodiment;

FIG. 9 is a flowchart showing another portion of behavior of the IC recorder 10 according to this embodiment;

FIG. 10 is a flowchart showing still another portion of behavior of the IC recorder 10 according to this embodiment;

FIG. 11 is a flowchart showing yet another portion of behavior of the IC recorder 10 according to this embodiment;

### DETAILED DESCRIPTION OF THE PREFERRED EMBODIMENTS

Hereinafter, as one embodiment of a recording and reproducing apparatus according to the present invention, an embodiment carried out for an IC recorder will be described along with the drawings specifically.

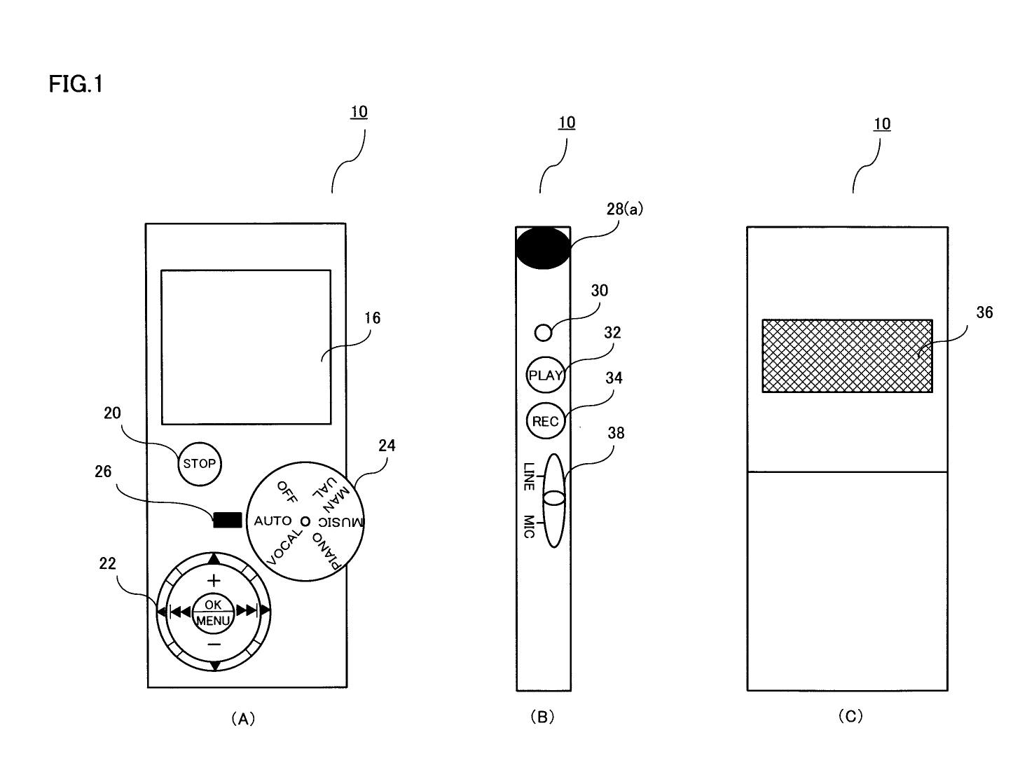

FIG. 1 is an outline view of an IC recorder 10 according to this embodiment. FIG. 1 (A) shows a front surface of a housing provided with a liquid crystal display device (an LCD portion) 16, a stop button 20, a cursor key 22 including a reproduction pausing function, a setting function, a menu calling function, a shifting function and a volume adjusting function, and a mode dial 24. A mark shown as 26 is a position mark for indicating a folder which is currently set by the mode dial 24 and is printed on the housing. A variety of settings described later is performed by operating the mode dial 24 so that any one of character strings printed on the mode dial 24 such as “AUTO”, “OFF”, “MANUAL”, “MUSIC”, “PIANO” and “VOCAL” are placed on a line nearly parallel to a position mark 26.

Here, in a word, an operation of placing the character string of the mode dial 24 by an user means a selection operation, and therefore, the placing operation will be described by regarding as the selection operation, hereafter. For example, when the character string “AUTO” is placed on the line nearly parallel to the position mark 26, it is regarded that an auto mode is selected. Moreover, when the character string “OFF” is placed on the line nearly parallel to the position mark 26, it is regarded that a power-off is selected. Similarly, a manual mode is selected in a case of the character string “MANUAL”, a music mode is selected in a case of the character string “MUSIC”, a piano mode is selected in a case of the character string “PIANO”, and a vocal mode is selected in a case of the character string “VOCAL”.

FIG. 1 (B) shows a right side surface of the housing, and a microphone 28a (Right) is installed on an upper portion of the housing. It is noted that, a microphone 28b (Left) is installed on an upper portion of a left side surface of the housing (not shown), and therefore, it becomes possible to perform a stereo recording by using the two microphones. A number 30 indicates a line terminal, a number 32 indicates a reproducing button, and a number 34 indicates a sound-recording button. A number 38 indicates an input changeover switch to switch whether inputting sound from the microphones 28a and 28b or inputting the sound from the line terminal 30.

FIG. 1 (C) shows a rear surface of the housing in which a speaker 36 is installed.

The IC recorder 10 according to this embodiment has a sound-recording function and a reproducing function, and shifts to a mode selected by operating the mode dial 24. Specifically, when the power-off is selected, the IC recorder 10 is transitioned to a power-off state, and when a mode except the power-off is selected, each mode is entered. In the power-off state, when the character string except “OFF” is placed on the line nearly parallel to the position mark 26 by the operation of the mode dial 24, the IC recorder 10 is automatically transitioned to the power-on state and a mode corresponding to the character string is also entered.

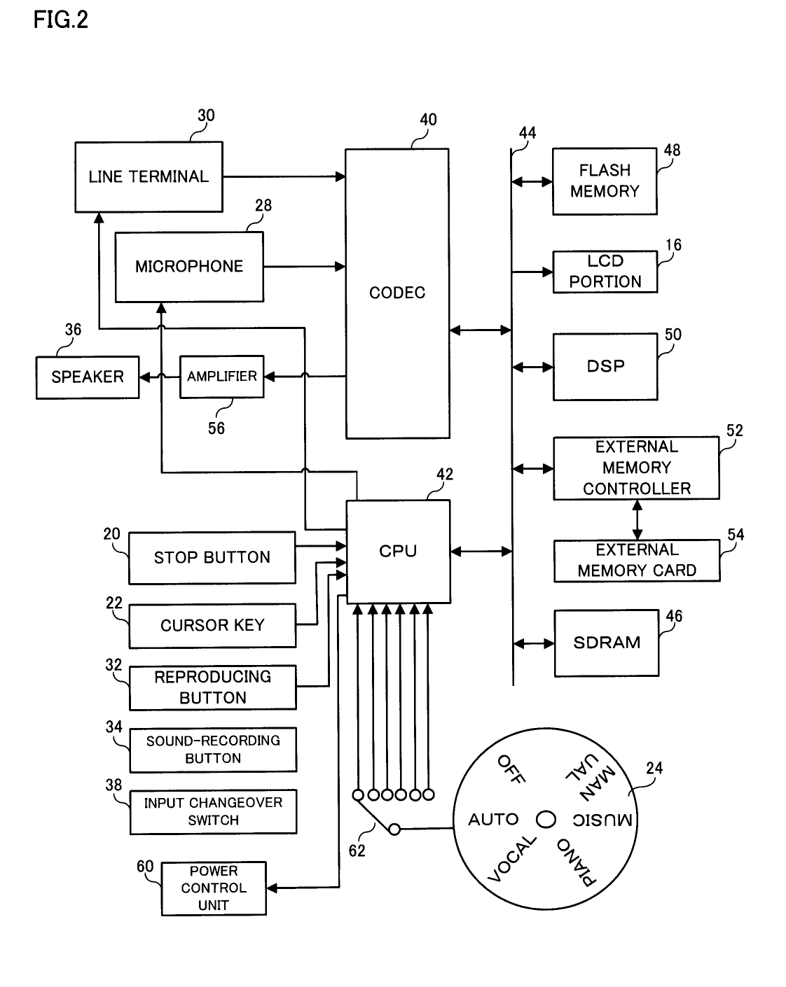

FIG. 2 shows a block diagram of the IC recorder 10.

The IC recorder 10 includes the microphone 28 (28a and 28b), and an analog sound signal collected from the microphone 28 by performing a recording-start operation is inputted to a codec 40 connected with the microphone 28. Alternatively, an analog sound signal inputted from the line terminal 30 is inputted to the codec 40. The codec 40 converts the inputted analog sound signal into a digital signal and performs a predetermined digital process.

A CPU 42 which controls a whole of the IC recorder 10 is connected with a bass 44 and temporarily accommodates digital sound data on which the digital process is performed by the codec 40 into an SDRAM 46. To the bass 44, the codec 40, the CPU 42, the SDRAM 46, a flash memory 48, the LCD portion 16, a DSP (Digital Signal Processor) 50 and an external memory controller 52 are connected, and in the flash memory 48, a program executed by the CPU 42 and a parameter to execute the program, etc., are stored.

Moreover, the stop button 20, the cursor key 22, the reproducing button 32, the sound-recording button 34 and the input changeover switch 38 are connected with the CPU 42, and when these buttons are operated, the CPU 42 comprehends the operation content so as to execute a program corresponding to the operation content by using the parameter to execute the program. It is noted that, the mode dial 24 is connected with the CPU 42 through a mode switch 62, and when the mode dial 24 is operated, the CPU 42 comprehends the mode content through the mode switch 62 so as to execute a program corresponding to the mode content by using the parameter to execute the program. Here, when the power-off is selected on the mode dial 24, the CPU 42 controls a power control section 60 so as to turn off the power of a main unit.

Next, when an MP3 system is adopted as a file format upon recording, the digital sound data temporarily accommodated in the SDRAM 46 is outputted to the DSP 50. Thereafter, the DSP 50 performs a compression process on the inputted digital sound data in the MP3 format so as to temporarily accommodate into the SDRAM 46 as an MP3 sound file. Then, the CPU 42 controls the external memory controller 52 so as to record the MP3 sound file accommodated in the SDRAM 46 on the external memory card 54.

Moreover, when a PCM system is adopted as the file format, the digital sound data temporarily accommodated in the SDRAM 46 is made into a PCM formatted sound file. Thereafter, the CPU 42 controls the external memory controller 52 so as to record a PCM sound file accommodated in the SDRAM 46 on the external memory card 54. In this embodiment, each sound file is recorded on the external memory card 54, however, a nonvolatile internal memory not shown may be arranged in the IC recorder 10 for recording. The above-described processes from collecting sound to recording are defined as a sound-recording process, and a mode in which these processes are performed is defined as a sound-recording mode. Moreover, a mode in which a reproducing process described later is performed is defined as a reproduction mode.

A sound reproducing process is started and executed by operating the reproducing button 32 or operating the cursor key 22 in the reproduction mode. Specifically, when the MP3 sound file is subject to be reproduced, the file is temporarily accommodated into the SDRAM 46 from the external memory card 54, and then, a decompressing process is performed in the DSP 50. A digital decompressed sound signal on which the decompressing process is performed is accommodated into the SDRAM 46 again and is outputted to the codec 40. When a sound file to be reproduced is a PCM formatted sound file, the file is outputted from the external memory card 54 to the codec 40.

In the codec 40, an amplifying process is performed by converting the digital decompressed sound signal into an analog decompressed sound signal and outputting the signal to an amplifier 56. Thereafter, the signal is outputted to the speaker 36. It is noted that, in this embodiment, each sound file recorded in the external memory card 54 is reproduced, however, the nonvolatile internal memory not shown may be arranged in the IC recorder 10 for reproducing each sound file recorded in the memory.

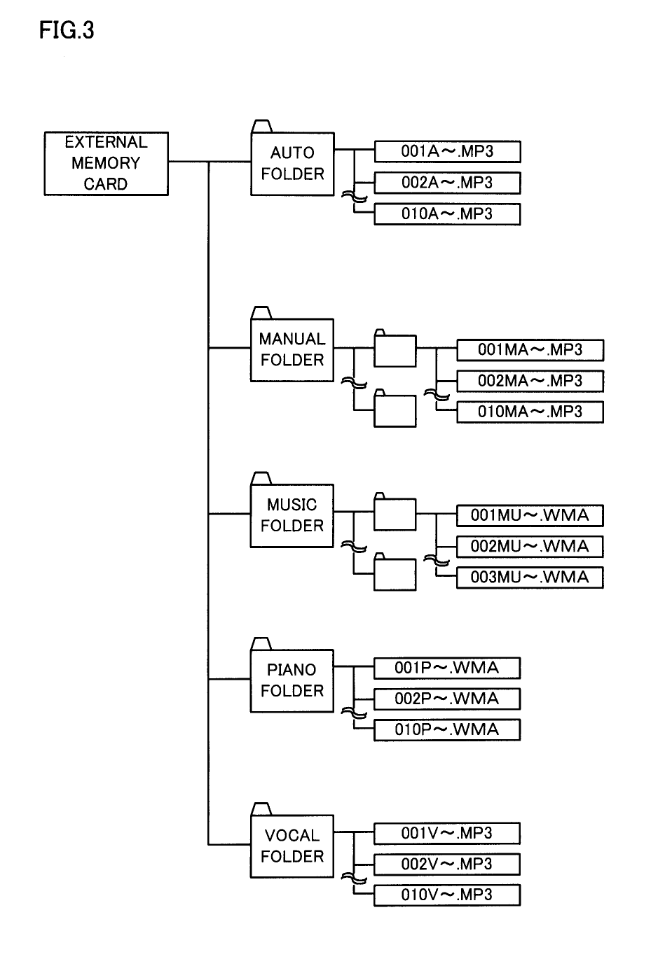

FIG. 3 shows a configuration of folders in the external memory card 54 which is configured by an AUTO folder, a MANUAL folder, a MUSIC folder, a PIANO folder and a VOCAL folder. In each folder, a plurality of sound files are accommodated.

Subsequently, operations of the IC recorder 10 in the sound-recording mode and the reproduction mode will be described in detail.

In the IC recorder 10 according to this embodiment, the mode dial 24 is installed as described above, and the variety of settings are performed by operating the mode dial 24 in the sound-recording mode and selecting any one of the auto mode, the power-off, the manual mode, the music mode, the piano mode, and the vocal mode. Specifically, when the auto mode is selected, the AUTO folder is allocated as a folder on which the sound file is to be recorded. Similarly, the MANUAL folder is allocated when the manual mode is selected, the MUSIC folder is allocated when the music mode is selected, the PIANO folder is allocated when the piano mode is selected, and the VOCAL folder is allocated when the vocal mode is selected. It is noted that, in the MANUAL folder and the MUSIC folder, a plurality of folders further exists; folders capable of being selected by the user operating the cursor key 22, for example.

Here, the folder on which the sound file is to be recorded is allocated corresponding to the selected mode, and concurrently, a recording system of the sound file, i.e., a function for performing the recording process is set.

It is noted that, as for each character string, indicating each mode, which is printed on the mode dial 24, the character string that is easy to understand for the user is adopted.

The character string “AUTO” indicating the auto mode means that it is not necessary for the user to consider a detailed setting and usage upon the sound-recording, and the character string “MANUAL” indicating the manual mode means that it is possible for the user to set the detailed setting and the usage upon the sound-recording. The character string “MUSIC” indicating the music mode shows that it is suitable for recording music, and the character string “PIANO” indicating the piano mode shows that it is suitable for mainly recording a sound generated from a piano. The character string “VOCAL” indicating the vocal mode shows that it is suitable for mainly recording voice of a human.

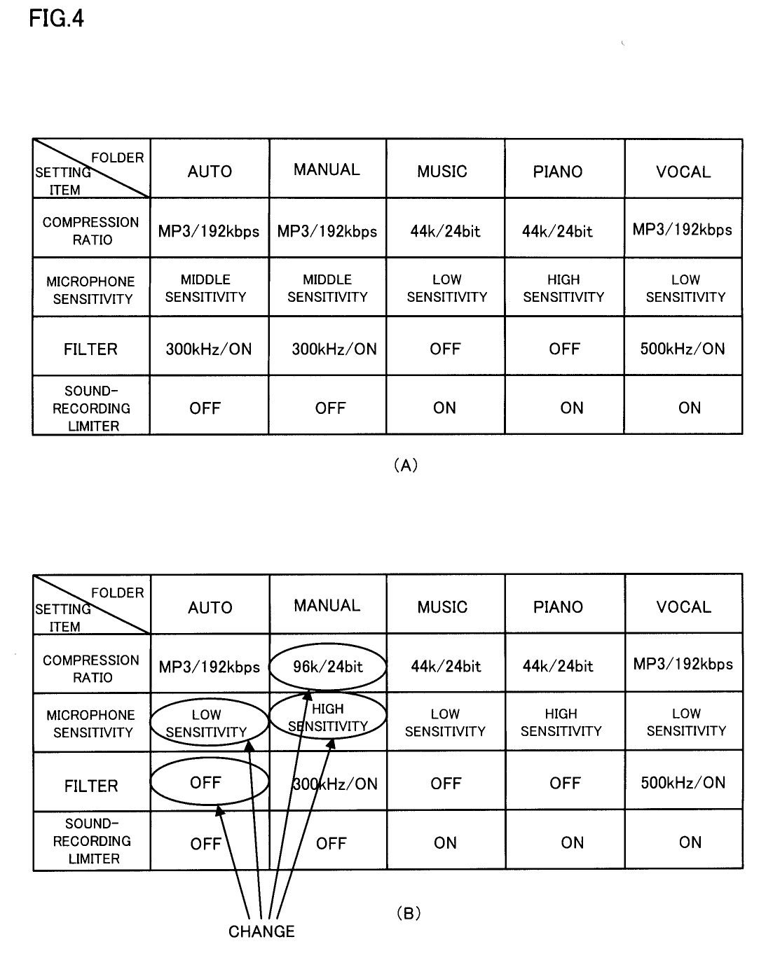

FIG. 4 (A) is a tale showing a relationship between the folders to be allocated and sound-recording-function setting items. The table is accommodated in the flash memory 48, and the CPU 42 performs each setting with reference to the table.

As shown in FIG. 4, the analog sound signal inputted through the microphone 28 or the line terminal 30 is recorded on each folder by the CPU 42 controlling the microphone 28, the codec 40 and the DSP 50 with reference to the table and performing processes along with the sound-recording-function setting items respectively.

As the sound-recording-function setting items, following items are provided: “compression ratio” upon compressing the sound; “microphone sensitivity” of the microphone 28; fan noises of an air-conditioning sound and a projector; a level of “filter” to reject a low frequency corresponding to a wind noise, etc. upon the sound-recording outdoors and “sound-recording limiter” to inhibit sudden excessive inputting during the sound-recording.

For a specific operation example, the auto mode is selected by operating the mode dial 24, and in a case where a certain sound is recorded on the AUTO folder, the CPU 42 controls the microphone 28 with reference to the table so as to set the microphone sensitivity to a middle sensitivity and controls the codec 40 so as to perform a process of rejecting a sound equal to or less than 300 kHz by controlling the codec 40.

It is noted that, it is possible to change the sound-recording-function setting items of the table, and the table shown in FIG. 4 (A) is a table which is set before the user uses for the first time or when resetting is performed. FIG. 4 (B) shows a table after the sound-recording-function setting items of the table are changed. It is noted that, it is possible to change the setting items in a case where the sound is recorded on the AUTO folder. Even if the power is turned off, the sound-recording-function setting items are maintained.

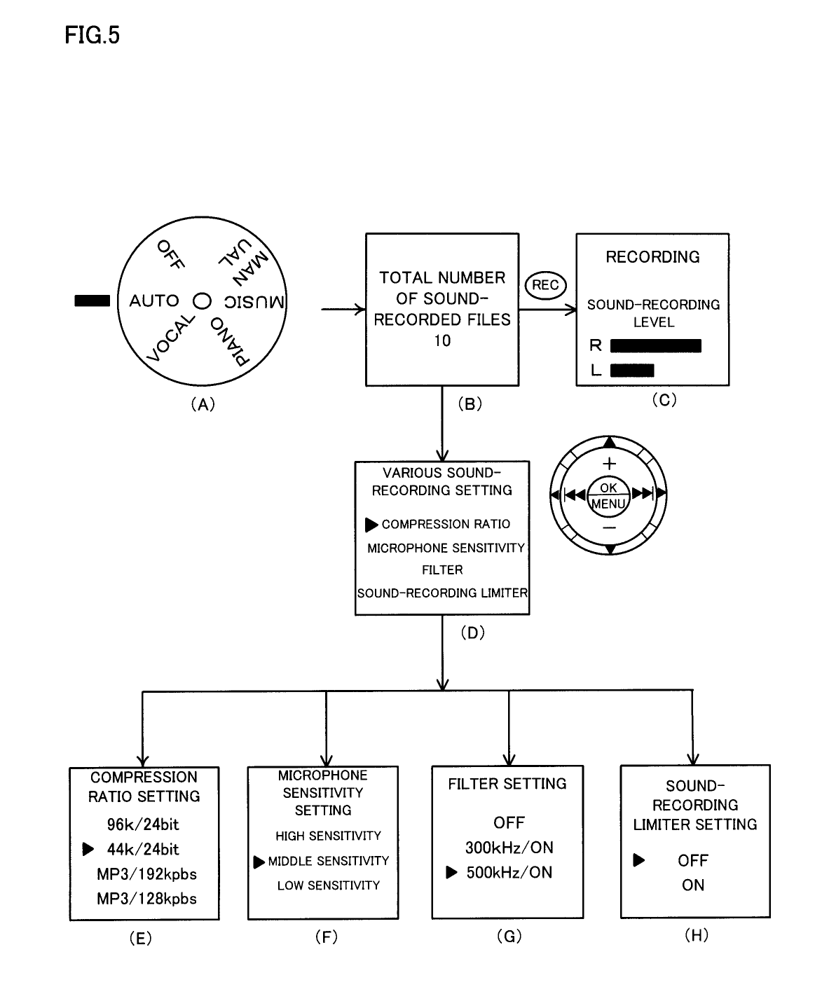

FIG. 5 is a figure showing a transition when the sound-recording-function setting items are changed.

When the auto mode is selected by operating the mode dial 24 (FIG. 5 (A)), the total number of the files accommodated in the AUTO folder is displayed on the LCD portion 16 (FIG. 5 (B)). When the sound-recording button 34 is operated in a state where the total number of the files is displayed as shown in FIG. 5 (B), the CPU 24 controls each section with reference to the table accommodated in the flash memory 48 so as to start to execute the sound-recording process, and concurrently, displays a character string indicating the sound-recording being in progress and a level of the sound inputted from the microphones 28a and 28b, i.e., a sound-recording level on the LCD portion 16 (FIG. 5 (C)).

In a state where the total number of the files is displayed as shown in FIG. 5 (B), when an operation equivalent to the menu calling function is performed on the cursor key 22, the LCD portion 16 shifts to a screen for the variety of sound-recording setting, and the four setting items such as “compression ratio”, “microphone sensitivity”, “filter” and “sound-recording limiter” are displayed so that one item is capable of being selected from among these functions (FIG. 5 (D)).

In a state where the four setting items are displayed on the LCD portion 16 as shown in FIG. 5 (D), when operations equivalent to the shift function and the setting function are performed on the cursor key 22 so as to select any one of the items, the LCD portion 16 shifts to setting screens of each item. When the item “compression ratio” is selected, four setting items of the compression ratio such as “96 k/24 bit”, “44 k/24 bit”, “MP3/192 kbps” and “MP3/128 kbps” are displayed so that one item is capable of being selected from among these items (FIG. 5 (E)).

Here, the item “96 k/24 bit” indicates that a sound signal is divided into 96,000 signals per second and a loudness of the sound is represented with two to the power 24 (16,780,000 tones). The item “44 k/24 bit” indicates that the sound signal is divided into 44,000 signals per second and the loudness of the sound is represented with 16,780,000 tones. The item “MP3/192 kbps” indicates that the sound signal is compressed with a transfer efficiency of 192 kbps in the MP3 format. The item “MP3/128 kbps” indicates that the sound signal is compressed with a transfer efficiency of 128 kbps in the MP3 format.

Moreover, when the item “microphone sensitivity” is selected in a display state shown in FIG. 5 (D) on the LCD portion 16, three microphone-sensitivity setting items such as “high sensitivity”, “middle sensitivity”, and “low sensitivity” are displayed so that one item is capable of being selected from among these items (FIG. 5 (F)).

Here, the microphone sensitivity indicates at which level the analog sound signal collected from the microphone 28 is outputted, and the item “high sensitivity” indicates a high level, the item “middle sensitivity” indicates a middle level, and the item “low sensitivity” indicates a low level.

Similarly, when the item “filter” is selected in the display state shown in FIG. 5 (D) on the LCD portion 16, three filter setting items such as “OFF”, “300 kHz/ON”, and “500 kHz/ON” are displayed so that one item is capable of being selected from among these items (FIG. 5 (G)).

Here, the item “300 kHz/ON” indicates that a part of the sound signal equal to or less than 300 kHz is rejected, and the item “500 kHz/ON” indicates that a part of the sound signal equal to or less than 500 kHz is rejected.

Similarly, when the item “sound-recording limiter” is selected in the display state shown in FIG. 5 (D) on the LCD portion 16, two sound-recording limiter setting items such as “OFF” and “ON” are displayed so that one of them is capable of being selected (FIG. 5 (H)).

Subsequently, the operation in the reproduction mode will be described. In the reproduction mode, the variety of settings are performed by the user operating the mode dial 24 and selecting any one of the auto mode, the power-off, the manual mode, the music mode, the piano mode, and the vocal mode. Specifically, when the auto mode is selected, the AUTO folder is allocated as a folder in which the sound file is to be reproduced. Similarly, the MANUAL folder is allocated when the manual mode is selected, the MUSIC folder is allocated when the music mode is selected, the PIANO folder is allocated when the piano mode is selected, and the VOCAL folder is allocated when the vocal mode is selected. It is noted that, in the MANUAL folder and the MUSIC folder, a plurality of folders further exists; folders capable of being selected by the user operating the cursor key 22, for example.

Here, the folder in which the sound file is to be reproduced is allocated corresponding to the selected mode, and concurrently, a reproducing system of the sound file, i.e., a function for performing the reproducing process is set.

It is noted that, as described above, as for each character string, indicating each mode, which is printed on the mode dial 24, the character string that is easy to understand for the user is adopted.

The character string “AUTO” indicating the auto mode means that it is not necessary for the user to consider the detailed setting and usage upon reproducing, and the character string “MANUAL” indicating the manual mode means that it is possible for the user to set the detailed setting and the usage upon reproducing. The character string “MUSIC” indicating the music mode shows that it is suitable for reproducing a music file, and the character string “PIANO” indicating the piano mode shows that it is suitable for reproducing the music file in which the sound generated from the piano is mainly recorded. The character string “VOCAL” indicating the vocal mode shows that it is suitable for reproducing a sound file in which the voice of the human is mainly recorded.

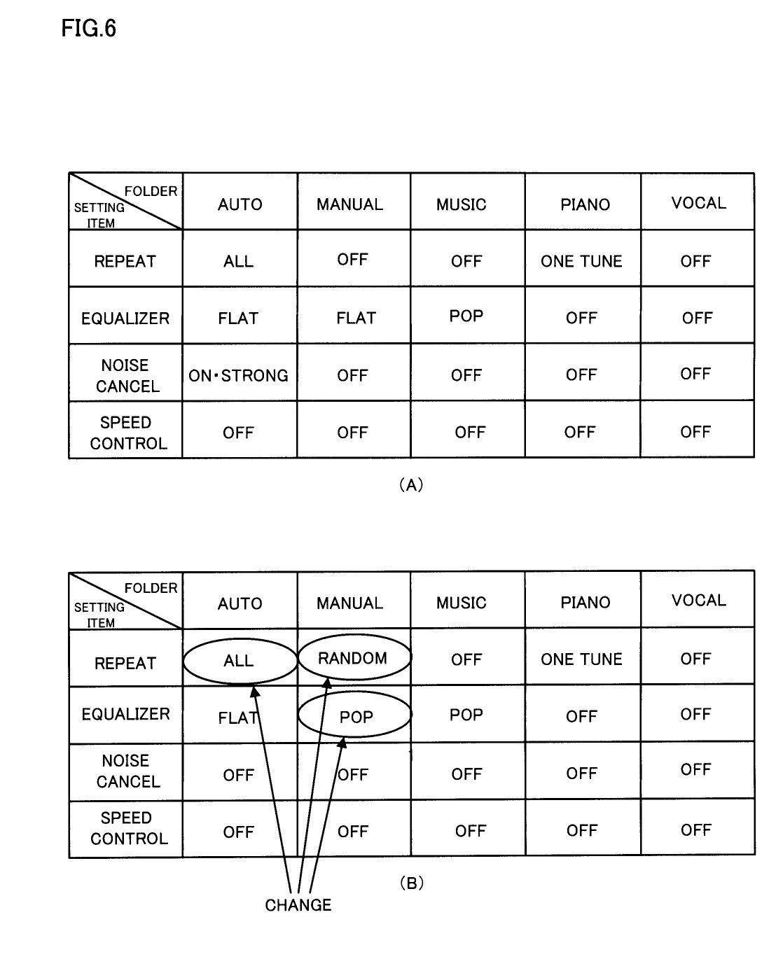

FIG. 6 (A) is a tale showing a relationship between the folders to be allocated and reproducing-function setting items. The table is accommodated in the flash memory 48, and the CPU 42 performs each setting with reference to the table.

As the reproducing-function setting items, following items are provided: a setting of “repeat” for the sound file; a setting of “equalizer” to emphasize or decrease a specific frequency band of the sound signal; a setting of “noise cancel” to reduce a background noise and a setting of “speed control” to control a reproducing speed.

Specifically, when the auto mode is selected by operating the mode dial 24, it becomes possible to reproduce a certain sound file from the AUTO folder. Then, when the sound file is reproduced, as a result of the CPU 42 referring to the table, a repeating function becomes ineffective, a noise cancelling function and a speed controlling function are set to initial values, a frequency characteristic of the sound signal based on the sound file is adjusted in an equalizing function so as to be a same level in a low-band, a middle-band and a high-band. It is noted that, it is possible to change the reproducing-function setting items of the table, and the table shown in FIG. 6 (A) is a table which is set before the user uses for the first time or when resetting is performed. FIG. 6 (B) shows a table after the reproducing-function setting items of the table are changed. It is noted that, it is possible to change the reproducing-function setting items in a case where the sound file in the AUTO folder is reproduced. Even if the power is turned off, the reproducing function-setting items are maintained.

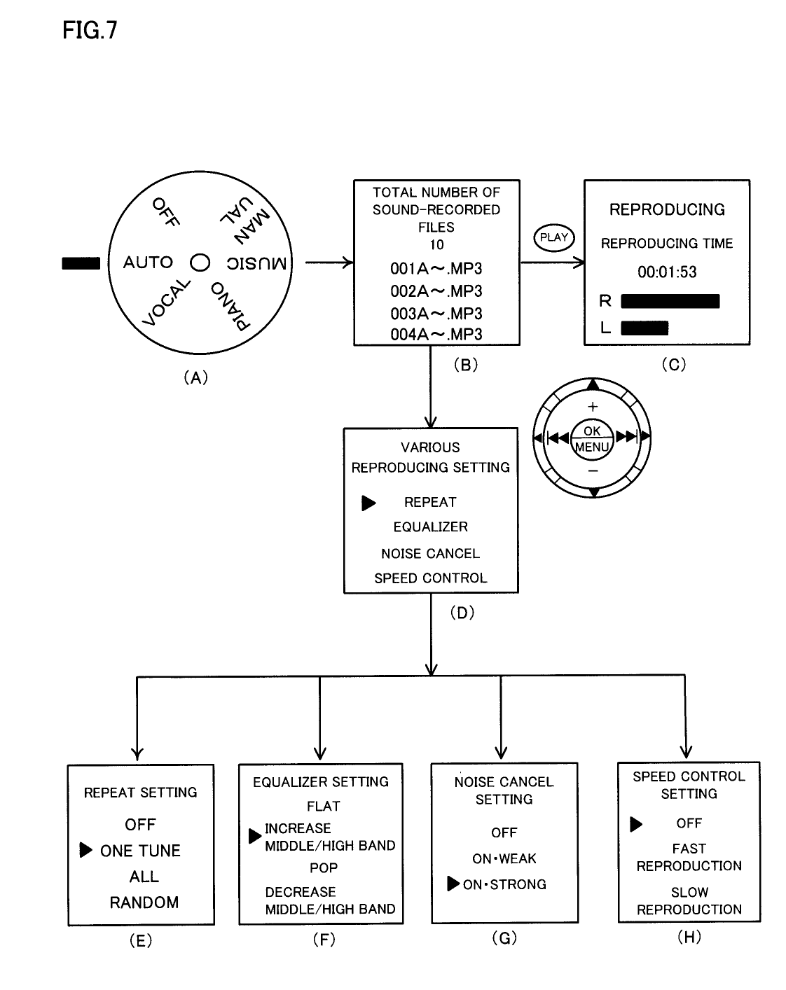

FIG. 7 is a chart showing a transition when the reproducing-function setting items are changed.

When the auto mode is selected by operating the mode dial 24 (FIG. 7 (A)), the total number of the files accommodated in the AUTO folder is displayed on the LCD portion 16 (FIG. 7 (B)). When the reproducing button 32 is operated in a state where the total number of the files is displayed as shown in FIG. 7 (B), the CPU 24 controls each section with reference to the table accommodated in the flash memory 48 so as to start to execute the sound reproducing process, and concurrently, displays a character string indicating the reproducing being in progress and a level of the sound outputted to the speaker 36 on the LCD portion 16 (FIG. 7 (C)).

In a state where the total number of the files is displayed as shown in FIG. 7 (B), when an operation equivalent to the menu calling function is performed on the cursor key 22, the LCD portion 16 shifts to a screen for the variety of reproducing setting, and the four reproducing-function setting items such as “repeat”, “equalizer”, “noise cancel” and “speed control” are displayed so that one item is capable of being selected from among these functions (FIG. 7 (D)).

When operations equivalent to the shift function and the setting function are performed on the cursor key 22 so as to select any one of the items in a state where the four setting items are displayed on the LCD portion 16 as shown in FIG. 7 (D), the LCD portion 16 shifts to setting screens of each item. When the item “repeat” is selected, four repeat setting items such as “OFF”, “one tune”, “ALL” and “random” are displayed so that one item is capable of being selected from among these items (FIG. 7 (E)).

Here, the item “one tune” indicates that a designated sound file is repeatedly reproduced, the item “ALL” indicates that all the sound files in a folder that the designated sound file belongs are repeatedly reproduced in order of file numbers, and the item “random” indicates that all the sound files in the folder that the designated sound file belongs are randomly and repeatedly reproduced irrespective of the file numbers.

Similarly, when the item “equalizer” is selected in the display state shown in FIG. 7 (D) on the LCD portion 16, four equalizer setting items such as “middle/high band increasing”, “middle/high band decreasing”, “flat” and “POP” are displayed so that one item is capable of being selected from among these items (FIG. 7 (F)).

Here, the item “middle/high band increasing” indicates that levels of the sound signal in the middle band and the high band are increased. As a result, it becomes possible to hear a voice of a human such as a vocalist remarkably. The item “middle/high decreasing” indicates that the levels of the sound signal in the middle band and the high band are decreased slightly. As a result, a sound file such as a classic music is reproduced in the middle band mainly, and therefore, it becomes listenable and easy to set the mood. The item “flat” indicates that the level of the frequency characteristic is equal in all of the low band, the middle band and the high band. The item “POP” indicates that the low band is increased, the middle band is decreased and the high band is increased. As a result, a sound quality is modulated.

Similarly, when the item “noise cancel” is selected in the display state shown in FIG. 7 (D) on the LCD portion 16, three noise cancel setting items such as “OFF”, “ON: weak”, and “ON: strong” are displayed so that one item is capable of being selected from among these items (FIG. 7 (G)).

The item “OFF” indicates that the noise cancelling is not performed, the item “ON: weak” indicates that a comparatively-weak sound signal of an opposite phase for deleting a noise component is generated, and the item “ON: strong” indicates that a comparatively-strong sound signal of the opposite phase is generated.

Similarly, when the item “speed control” is selected in the display state shown in FIG. 7 (D) on the LCD portion 16, three speed control setting items such as “OFF”, “fast reproduction”, and “slow reproduction” are displayed so that one item is capable of being selected from among these items (FIG. 7 (H)).

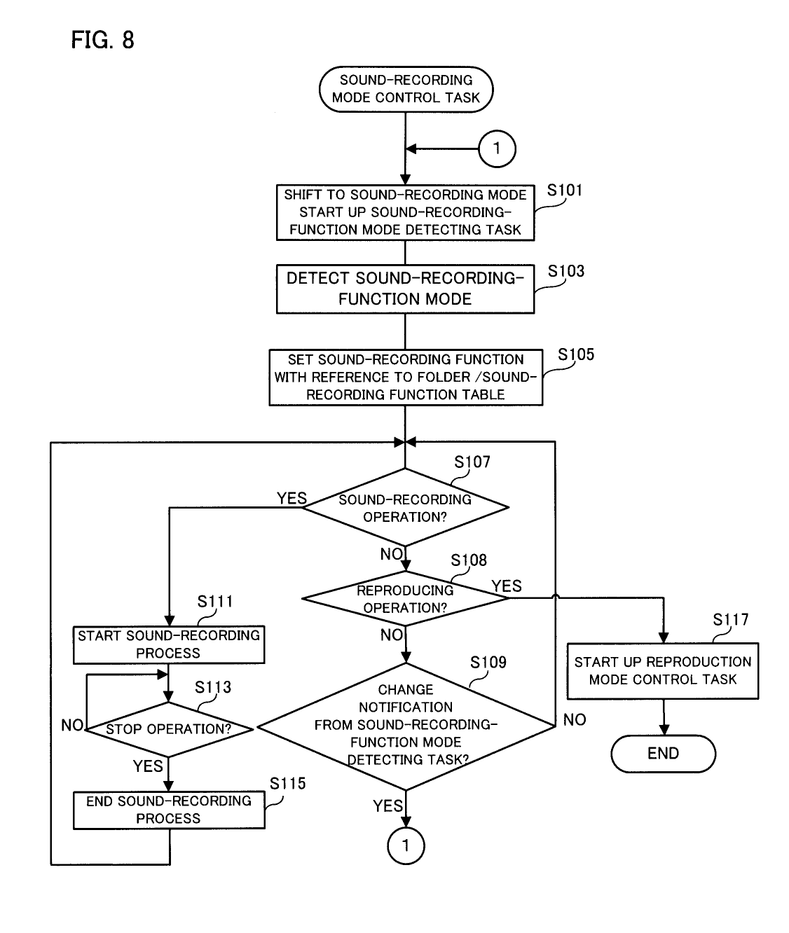

Subsequently, with reference to FIG. 8 to FIG. 11, processes in the above-described sound-recording and reproduction mode will be described. These processes are realized by the CPU 42 executing each program accommodated in the flash memory 48. It is noted that, the CPU 42 is a multi task CPU, for example, and is capable of executing a plurality of processes in a parallel manner.

FIG. 8 is a flowchart of a sound-recording mode control task indicating one portion of the sound-recoding and reproducing process executed by the CPU 42.

When a power source is applied to the IC recorder 10, or when the sound-recording mode control task is started up by a reproduction mode control task described later, in a step S101, the CPU 42 sets a current operation mode to the sound-recording mode and starts up a sound-recording-function mode detecting task. Subsequently, the process advances to a step S103 so as to detect a mode currently selected by the mode dial 24. Subsequently, the process advances to a step S105 so as to determine a folder corresponding to the currently selected mode and perform the variety of sound-recording function settings corresponding to the folder with reference to the table accommodated in the flash memory 48.

Subsequently, the process advances to a step S107 so as to determine whether or not the sound-recording operation is performed on the sound-recording button 34. When NO is determined in the step S107, the process advances to a step S108 so as to determine whether or not the reproducing operation is performed on the reproducing button 32. When YES is determined in the step S108, the process advances to a step S117 so as to start up the reproduction mode control task, and thereafter, the sound-recording mode control task is ended. When NO is determined in the step S108, the process advances to a step S109 so as to determine whether or not a change notification is notified from the sound-recording-function mode detecting task. When YES is determined in the step S109, the process returns to the step S103 while when NO is determined, the process returns to the step S107.

When YES is determined in the step S107, the process advances to a step S111 so as to start up the sound-recording process by controlling each block shown in FIG. 2. Subsequently, the process advances to a step S113 so as to determine whether or not a stop operation is performed on the stop button 20. In the step S113, the process is repeated until YES is determined, and when YES is determined, the process advances to a step S115 so as to end the sound-recording process by controlling each block. Thereafter, the process returns to the step S107.

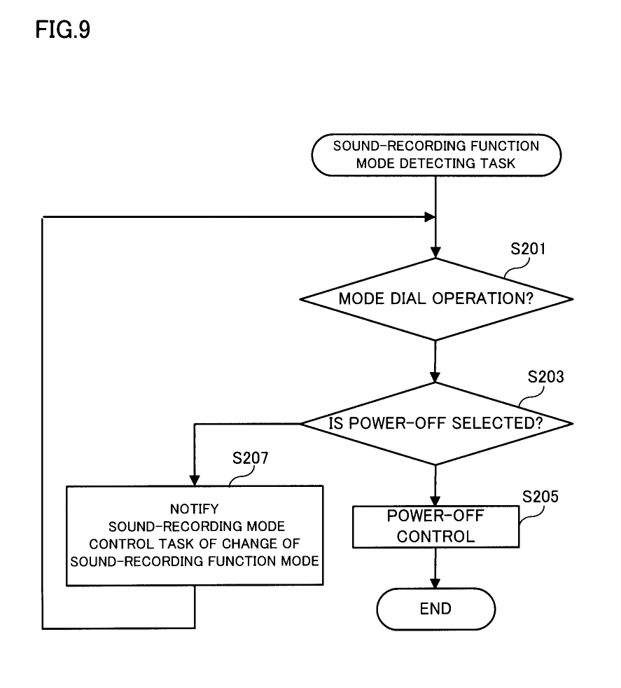

FIG. 9 is a flowchart of the sound-recording-function mode detecting task started up in the step S101 of the sound-recording mode control task executed by the CPU 42.

When the sound-recording-function mode detecting task is started up, firstly, in a step S201, it is determined whether or not the mode is changed by operating the mode dial 24. In the step S201, the process is repeated until YES is determined, and when YES is determined, the process advances to a step S203 so as to determine whether or not the power-off mode is selected as a result of the determination. When YES is determined in the step S203, the process advances to a step S205. In the step S205, the CPU 42 issues a command to the power control section 60 to turn off the power, and thereafter, the sound-recording function mode detecting task is ended.

When NO is determined in the step S203, the process advances to a step S207 so as to notify the sound-recording mode control task of a change of the mode. Thereafter, the process returns to the step S201.

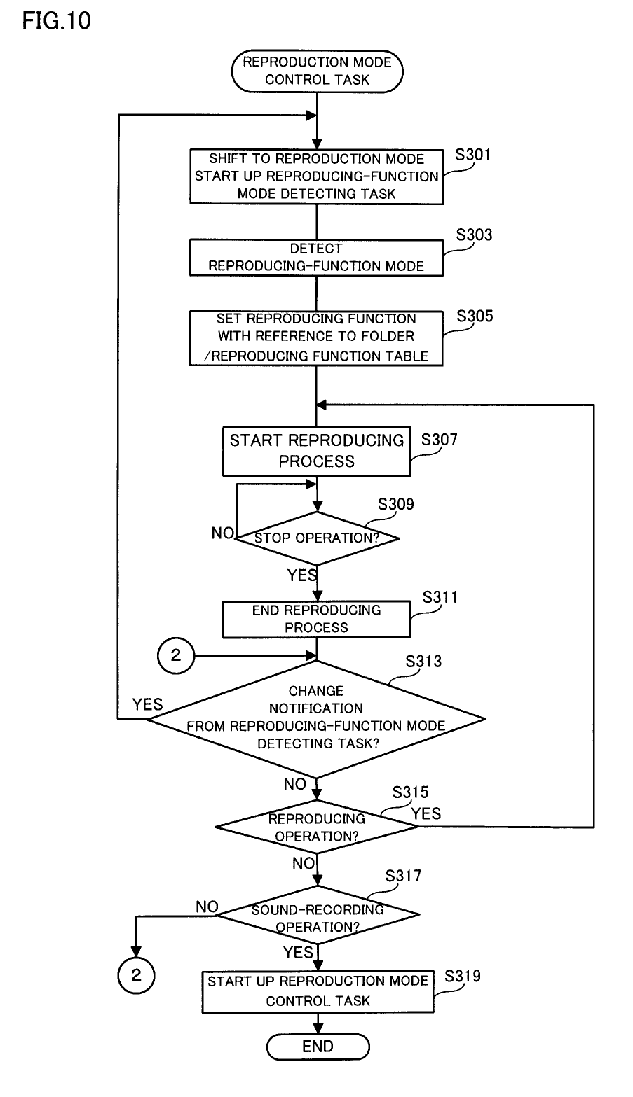

FIG. 10 is a flowchart of the reproduction mode control task started up in the step S108 of the sound-recording mode control task. Firstly, in a step S301, a current operation mode is set to the reproduction mode, and furthermore, a reproducing-function mode detecting task is started up. Thereafter, the process advances to a step S303 so as to detect a mode currently selected by the mode dial 24. Subsequently, the process advances to a step S305 so as to determine a folder corresponding to the currently selected mode and perform the variety of reproducing function settings corresponding to the folder with reference to the table accommodated in the flash memory 48.

Subsequently, the process advances to a step S307 so as to start up the reproducing process by controlling each block shown in FIG. 2. Thereafter, the process advances to a step S309. In the step S309, it is determined whether or not the stop operation is performed by the stop button 20. The process is repeated until YES is determined in the step S309, and when YES is determined, the process advances to a step S311 so as to end the reproducing process by controlling each block.

Subsequently, the process advances to a step S313 so as to determine whether or not a change notification is notified from the reproducing-function mode detecting task. When YES is determined in the step S313, the process returns to the step S303 while when NO is determined, the process advances to a step S315. In the step S315, it is determined whether or not the reproducing operation is performed by the reproducing button 32, and when YES is determined, the process returns to the step S307.

When NO is determined in the step S315, the process advances to a step S317 so as to determine whether or not the sound-recording operation is performed, and when NO is determined, the process returns to the step S313 while when YES is determined, the process advances to a step S319. In the step S319, the sound-recording mode control task is started up, and thereafter, the reproduction mode control task is ended.

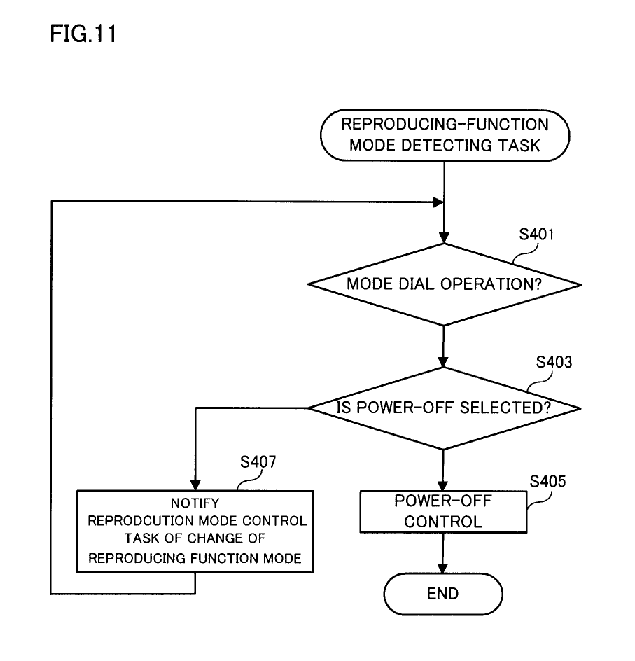

FIG. 11 is a flowchart of the reproducing-function mode detecting task started up in the step S301 of the reproduction mode control task.

When the reproducing-function mode detecting task is started up, firstly, in a step S401, it is determined whether or not the mode is changed by operating the mode dial 24. In the step S401, the process is repeated until YES is determined, and when YES is determined, the process advances to a step S403 so as to determine whether or not the power-off mode is selected as a result of the determination. When YES is determined in the step S403, the process advances to a step S405. In the step S405, the CPU 42 issues the command to the power control unit 60 to turn off the power, and thereafter, the reproducing-function mode detecting task is ended.

When NO is determined in the step S403, the process advances to a step S407 so as to notify the reproduction mode control task of a change of the mode. Thereafter, the process returns to a step S401.

As described above, in the IC recorder 10 according to this embodiment, when a revolved position of the mode dial 24 in a recording mode is the same as in the reproduction mode, the folder in which the sound file is allocated in the recording process at the time of the recording mode becomes the same as the folder in which the sound file of a reproduction destination is allocated, and therefore, it becomes easier to operate for the user to select the folders in the recording mode and the reproduction mode.

Moreover, in the IC recorder 10 according to this embodiment, the function associated with each of the recording process and the reproducing process is applied by simply operating the mode dial 24 and selecting the folder, and therefore, it becomes possible for the user to record or reproduce the sound file without a detailed setting.

Furthermore, it becomes possible to perform the power-off operation by the user simply operating the mode dial 24, and therefore, it is not necessary to arrange a power-off switch additionally.

Moreover, the function associated with each of the recording process and the reproducing process is alterable by the user, and therefore, it becomes possible to perform the recording and the reproducing according to the user's preference.

Thus, the mode dial 24 is operated in both the sound-recording mode and the reproducing mode, and is easy to be used intuitively because a process function suitable for each of the folders is set by the user as if designating the folder of the recording destination in a case of recording the sound and the folder in the reproducing destination in a case of reproducing.

It is noted that, the IC recorder 10 is described in this embodiment of the present invention, however, an imaging device or a hard disc recorder may be adopted.

Moreover, the sound file is described as a target to be recorded and reproduced in this embodiment, however, a target file may be a video file or a text file.

Furthermore, the sound-recording-function setting items and the reproducing-function setting items described in this embodiment are not limited in the above-described embodiment.

Moreover, in this embodiment, the mode dial 24 is adopted as the switch for selecting the folder, however, the switch is not only limited to this but also to any revolving switch. For example, even in a case where the variety of operations described in this embodiment is performed on a touch panel adopted for the LCD unit 16, the revolving switch may be associated with the LCD unit 16, in other words, a mode dial image may be operated by displaying it on a screen.

Moreover, in this embodiment, in a case where the mode dial 24 has been operated in the sound-recording process and the reproducing process, a folder and a mode of an allocation destination are not changed until the stop operation is performed by operating the stop button 20.

It is noted that, when the power is turned off corresponding to the set mode, the sound-recording-function setting items and the reproducing-function setting items may be reset.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A recording and reproducing apparatus provided with a recording mode which performs a recording process of recording content data on a recording medium, a reproduction mode which performs a reproducing process of reproducing the content data recorded on said recording medium, and a revolving switch capable of selecting a predetermined folder from among a plurality of folders in said recording medium corresponding to a revolved position, comprising:
a recording setter which sets, upon the recording mode, a first folder corresponding to a revolved position of said revolving switch, out of the plurality of folders in said recording medium, as an allocation destination of the content data to be recorded on said recording medium;
a reproducing setter which sets the content data allocated to a second folder corresponding to a revolved position of said revolving switch, out of the plurality of folders in said recording medium, as a reproducing destination, wherein the first folder and the second folder become the same folder out of the plurality of folders in said recording medium on the condition that the revolved position of said revolving switch in the recording mode is same as the revolved position of said revolving switch in the reproduction mode.

2. A recording and reproducing apparatus according to claim 1, wherein each of the plurality of folders is associated with a function which is applied to upon each of the recording process and the reproducing process, and the recording process and the reproducing process are performed by applying a function associated with a folder which is selected by said revolving switch.

3. A recording and reproducing apparatus according to claim 1, wherein a power-off is capable of being selected by operating said revolving switch, and when the power-off is selected, a part of devices of a main unit transitions to a non-start-up state.

4. A recording and reproducing apparatus according to claim 1, wherein the functions associated with the plurality of folders respectively are alterable by user's operation.
